(19) United States
(12) Patent Application Publication
(10) Pub. No.: US 2005/0064979 A1
(43) Pub. Date: Mar. 24, 2005

(54) Bevel gear transmission

(76) Inventors: Tatsuji Suganuma, Toyota-shi (JP); Takashi Matsuda, Toyota-shi (JP); Kouichi Watanabe, Imizu-gun (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/496,991

(22) PCT Filed: Nov. 27, 2002
(86) PCT No.: PCT/IB02/04958

(30) Foreign Application Priority Data
Nov. 28, 2001 (JP) 2001-362807

(51) Int. Cl. F16H 48/06

(52) U.S. Cl. 475/246

(57) ABSTRACT

In a bevel gear transmission (1), in a rotating shaft (3) connected to a bevel pinion (2), a portion distanced from the bevel pinion (2), in which a lubricating condition is severe, is supported by an angular ball bearing (6) with which lubrication performance is easily ensured, and the other portion is supported by a tapered roller bearing (5) which exhibits superior fatigue durability, load withstanding ability and rigidity.

### BACKGROUND OF THE INVENTION

1. Field of the Invention

This invention relates to a bevel gear transmission.

2. Description of the Related Art

In a vehicle such as an automobile, a final reduction gear device is provided in a rotation transfer path between an engine and a wheel such that rotation is transferred between the engine side and the wheel side via a rotating shaft connected to the final reduction gear device. This final recuction gear device is formed as a bevel gear transmission. The rotating shaft is rotatably supported in the final gear reduction device by means of two bearings. The support structure for a rotating shaft in the final reduction gear device is explained referring to FIG. 7. FIG. 7 shows an enlarged sectional view of the portion in which the rotating shaft is supported in the final reduction gear device.

As shown in FIG. 7, a rotating shaft 91 is connected to a bevel pinion 93 of a final reduction gear device 92. Therefore, when rotation is transferred between the engine side and the wheel side via the rotating shaft 91, the bevel pinion 93 is engaged and rotates, and reaction force produced upon the rotation acts on the rotating shaft 91 as a radial load and thrust load. Further, deflection is produced in the rotating shaft 91 due to the radial load and thrust load.

Therefore, a bearing supporting the rotating shaft 91 is required to have a load withstanding ability for receiving the radial load and thrust load, durability against fatigue (hereinafter referred to as “fatigue durability”) caused by both of the loads, and rigidity for inhibiting deflection of the rotating shaft 91 caused by both of the loads. For these reasons, a tapered roller bearing 94 is adopted as a bearing appropriate for supporting the rotating shaft 91 so as to ensure the necessary load withstanding ability, fatigue durability, and rigidity.

In the tapered roller bearing 94, a roller 95 is sandwiched so as to be able to rotate, in a state in which an axial line of the roller 95 is inclined with respect to the rotating shaft 91, between an inner ring 96 and an outer ring 97. In the tapered roller bearing 94, the roller 95 and the inner ring 96, as well as the roller 95 and the outer ring 97, respectively, contact one another in a state of almost line contact such that the entire line contact portion receives the radial load and thrust load. Therefore, it is possible to maintain the load withstanding ability in order to receive the radial load and thrust load, as well as the durability against fatigue due to both of the loads at the necessary levels.

In addition, the tapered roller bearing 94 is normally used in pairs. Two tapered roller bearings 94 are installed facing opposite directions on the final reduction gear device 92 supporting the rotating shaft 91 such that the tapered roller bearings are symmetric across a plane F perpendicular to the rotating shaft 91. Further, in a state where the tapered roller bearing 94 is installed, a predetermined pressure is applied from the inner ring 96 and the outer ring 97 to the roller 95, thereby the rigidity as a bearing is increased to the necessary level.

Of the two tapered roller bearings 94, one (the one on the left side in the figure) receives the radial load and the thrust load which acts in the direction to the right in the figure when the vehicle goes forward, and the other (the one on the right side in the figure) receives the radial load and the thrust which acts in the direction to the left in the figure when the vehicle goes backward. In the state where the radial load and the thrust load are received, the roller 95 of the tapered roller bearing 94 rolls between the inner ring 95 and the outer ring 97 when the rotating shaft 91 rotates. The rolling of the roller 95 is guided by a collar portion 96a provided on the edge portion of the outer peripheral surface of the inner ring 96.

The tapered roller bearing 94 is lubricated with lubricating oil (not shown), enclosed in a housing 92a of the final reduction gear device 92. In other words, when a gear or the like of the final reduction gear device 92 is driven by the rotation of the rotating shaft 91, the lubricating oil in the housing 92a of the final reduction gear device 92 is agitated, scooped up, and supplied to the tapered roller bearing 94. The lubricating oil enters between the inner ring 96 and the roller 95, as well as between the outer ring 97 and the roller 95, respectively, in the tapered roller bearing 94 so as to form an oil film, and lubricates the applicable portions. The rotating shaft 91 is able to rotate at the same speed as the engine speed or at a higher speed. Therefore, the environment in which the tapered roller bearing 94 supporting the rotating shaft 91 is used is more severe than that for other bearings used in the other portion. Accordingly, the lubrication between the inner ring 96 and the roller 95, as well as the outer ring 97 and the roller 95 is extremely important.

In order to improve the fuel efficiency of the in-vehicle engine or the like, it is desirable to reduce the rotation resistance of the drive train such as the final reduction gear device 92 or the rotating shaft 91. In order to satisfy this demand, as a possible solution, reducing the amount of the lubricating oil enclosed in the housing 92a of the final reduction gear device 92 or reducing the viscosity of the lubricating oil has been considered so as to reduce the agitation resistance of the lubrication oil when the rotating shaft 91 rotates.

However, in the tapered roller bearing 94, the rolling of the roller 95 is guided by the collar portion 96a of the inner ring 96 with a predetermined pressure applied from the inner ring 96 to the roller 95. For this reason, the collar portion 96a and the roller 95 rub against each other when the collar portion 96a is pressed against the roller 95, when the roller 95 rolls.

Therefore, if the amount of the lubricating oil is reduced and the viscosity thereof is reduced in a manner as mentioned above, of the two tapered roller bearings 94, at least one of the bearings which supports the portion of the rotating shaft 91 with the more severe lubricating condition has the following problems:
If the amount of the lubricating oil is reduced, the lubricating oil has difficulty reaching between the collar portion 96a and the roller 95, and seizure may easily occur in that location.
If the viscosity of the lubricating oil is reduced, it is difficult for an oil film produced by the lubricating oil to form between the collar portion 96a and the roller 95 when there is a high load during low speed rotation of the rotating shaft 91, such that seizure may be induced in that location.

Seizure between the collar portion 96a and the roller 95 tends to occur especially when, after the final reduction gear device 92 starts to be driven from a cold state, temperature of only the inner ring 96 or the outer ring 97 of the tapered roller bearing 94 increases and the inner ring 96 or the outer ring 97 expands thermally, for example, and the difference of the thermal expansion between the inner ring 96 and the outer ring 97 increases the pressure applied between the collar portion 96a and the roller 95 such that an oil film has difficulty forming.

In order to inhibit this kind of seizure, it is conceivable to use an other bearing with high lubrication performance, instead of the tapered roller bearing 94, as a bearing for supporting the rotating shaft 91. However, mere replacement of the bearing with one having high lubrication performance may be inappropriate as a bearing for supporting the rotating shaft 91 in terms other than lubrication performance such as load withstanding ability, fatigue durability, and rigidity. For example, even if the bearing that is used instead of the tapered roller bearing 94 reaches the necessary level in lubrication performance, unless it reaches the necessary level in fatigue durability, there is a disadvantage that the usable period of the bearing is shortened.

### SUMMARY OF THE INVENTION

In view of the foregoing problems, it is an object of the invention to provide a bevel gear transmission in which a transmission loss can be reduced and seizure at the bearing can be inhibited even if an amount of lubricating oil and viscosity thereof are reduced, and further, problems such as insufficient fatigue durability of the bearing, load withstanding ability, and rigidity can be minimized.

Hereafter, a structure and the effects thereof in order to achieve the foregoing object will now be described.

In order to achieve the object, there is provided a bevel gear transmission according to the first aspect of the invention, in particular for the use as a final gear device in an automobile, comprising a bevel wheel meshing with a bevel pinion; a rotating shaft supporting said bevel pinion, said rotating shaft being supported by a plurality of bearings, wherein the one bearing arranged close to the bevel pinion is a tapered roller bearing disposed such that a thrust load of the rotating shaft is received by this tapered roller bearing, when said rotating shaft rotates in a forward direction and the thrust load of the rotating shaft is received by the other bearing arranged far from the bevel pinion, when said rotating shaft rotates in a reverse direction and the other bearing is a ball bearing.

With the ball bearing, the contact surfaces, in which the contact portion between the inner ring and the rolling body (ball), as well as the contact portion between the outer ring and the rolling body (ball), are almost in point contact, are small. Therefore, an oil film produced by the lubricating oil can form easily between the portions, and the necessary lubrication performance is easily ensured even if the amount of the lubricating oil and the viscosity thereof are reduced. Therefore, if some of the plurality of bearings supporting the rotating shaft are ball bearings (the second bearing) and the portion where the lubrication is difficult in the rotating shaft is supported by these bearings, it is possible to significantly reduce the rotation resistance of the rotating shaft and inhibit seizure at the bearing even if the amount of the lubricating oil and the viscosity thereof of the final reduction gear device are reduced. In addition, the second bearing (ball bearing) has the fatigue durability necessary for supporting the rotating shaft. Therefore, even if some of plurality of bearings supporting the rotating shaft are the second bearings, no problems, such as the usable period of the bearing becoming shorter, occur.

Moreover, according to the first aspect of the invention, the second bearing may be an angular ball bearing having a plurality of raceways for balls between the inner ring and the outer ring.

An angular ball bearing of a type having a single row is inferior in terms of the fatigue durability, load withstanding ability, and rigidity to a roller bearing, or the like, of the same size. Therefore, it is difficult to ensure the fatigue durability, load withstanding ability, and rigidity necessary for supporting the rotating shaft without increasing the size of the bearing.

However, if the angular ball bearing of a type having a plurality of rows is used as the second bearing which is a ball bearing, the radial load and thrust load acting on the rotating shaft are received by a plurality of rows of balls. Therefore, it is possible to maintain the fatigue durability and load withstanding ability as a bearing for supporting the rotating shaft at the necessary level or more without increasing the size of the bearing. In addition, in the angular ball bearing, the balls are pressed with a predetermined pressure such that the rigidity is increased by the inner and outer rings. Therefore, it is possible to maintain the rigidity as a bearing for supporting the rotating shaft at the necessary level or more without increasing the size of the bearing.

In the second aspect of the invention, a support structure in which a rotating shaft connected to a gear provided in a final reduction gear device of a vehicle is supported by a plurality of bearings, the plurality of bearings including a tapered roller bearing, and an angular ball bearing having the plurality of raceways for balls between an inner ring and an outer ring.

With the angular ball bearing, the balls and the inner ring, as well as the balls and the outer ring, respectively, contact in a state of almost point contact, such that both of the contact areas are small. Therefore, an oil film is easily formed between the contact portions and lubrication performance is easily ensured. In addition, the tapered roller bearing exhibits superior fatigue durability, load withstanding ability, and rigidity, so it is possible to ensure the fatigue durability, load withstanding ability, and rigidity of the support structure.

According to the second aspect of the invention, of the portions supported by the plurality of bearings, the portion in which the lubricating condition is more severe than it is at the other portion may be supported by the angular ball bearing having the plurality of raceways for balls between the inner ring and the outer ring, and the other portion may be supported by the tapered roller bearing.

According to this kind of structure, the portion in which the lubricating condition of the rotating shaft is severe is supported by the angular ball bearing with which lubrication performance is easily ensured, and the portion in which the lubricating condition is not very severe is supported by the tapered roller bearing which exhibits superior fatigue durability, load withstanding ability, and rigidity. Therefore, when the amount and viscosity of the lubricating oil of the final reduction gear device are reduced just to about the point where seizure does not occur in the tapered roller bearing, the rotation resistance of the rotating shaft can be significantly reduced. In this manner, the rotation resistance of the rotating shaft can be significantly reduced, and the seizure at the bearing can be inhibited at the same time. Moreover, the angular ball bearing receives the radial load and thrust load acting on the rotating shaft with the balls, and those balls are pressed by the inner ring and the outer ring with a predetermined pressure such that the rigidity as a bearing is increased. Therefore, it is possible to maintain the fatigue durability, load withstanding ability, and rigidity as the bearing for supporting the rotating shaft at the necessary level or more without increasing the size of the bearing. Moreover, there are no problems in terms of the fatigue durability, load withstanding ability, and rigidity.

In addition, of the portions of the rotating shaft supported by the plurality of angular ball bearings, the angular ball bearing may support the portion in which the lubricating condition is more severe than it is at the other portion and the load received is smaller than it is at the other portion.

In general, it is difficult to ensure the load withstanding ability with ball bearings. However, according to the aforementioned structure, in the portion supported by the angular ball bearing in the rotating shaft, the lubricating condition is more severe than it is at the other portion, and the load received is smaller than it is at the other portion. Therefore, no problems occur in terms of the load withstanding ability when the angular ball bearing is used as the bearing to support the rotating shaft.

Moreover, in the aforementioned second aspect of the invention, of the portions of the rotating shaft supported by the plurality of bearings, the portion in which the required deflection rigidity is higher than it is at the other portion may be supported by the tapered roller bearing, and the other portion may be supported by the angular ball bearing having the plurality of raceways for balls between the inner ring and the outer ring.

With the angular ball bearing, the balls and the inner ring, as well as the balls and the outer ring, respectively, contact in a state of almost point contact, such that the both of the contact areas are small. Therefore, an oil film is easily formed between the contact portions and lubrication performance is easily ensured. In addition, the angular ball bearing receives the radial load and thrust load acting on the rotating shaft with the balls, and those balls are pressed by the inner ring and the outer ring with a predetermined pressure such that the rigidity as the bearing is increased. For this reason, the fatigue durability, load withstanding ability, and rigidity of the angular ball bearing are maintained at a predetermined level or more without increasing the size of the bearing. According to the aforementioned structure, the portion in which the required deflection rigidity is higher than it is at the other portion of the rotating shaft is supported by the tapered roller bearing which exhibits superior rigidity, and the portion in which the high deflection rigidity is not required very much is supported by the angular ball bearing with which lubrication performance is easily ensured. In this manner, if the angular ball bearing is used, the rotation resistance of the rotating shaft can be significantly reduced and the seizure at the bearing can be inhibited even if the amount and the viscosity of the lubricating oil of the final reduction gear device are reduced. Moreover, the portion of the rotating shaft in which high rigidity is required is supported by the tapered roller bearing, and the other portion is supported by the angular ball bearing in which the rigidity is increased as mentioned above. Therefore, the rigidity of the bearing supporting the rotating shaft never becomes insufficient.

Moreover, in the second aspect of the invention, of the portions of the rotating shaft supported by the plurality of bearings, the portion in which the load received is larger than it is at the other portion may be supported by the tapered roller bearing, and the other portion may be supported by the angular ball bearing having the plurality of raceways for balls between the inner ring and the outer ring.

With the angular ball bearing, the balls and the inner ring, as well as the balls and the outer ring, respectively, contact in a state of almost point contact, such that both of the contact areas are small. Therefore, an oil film is easily formed between the contact portions and lubrication performance is easily ensured. In addition, the angular ball bearing receives the radial load and thrust load acting on the rotating shaft with the balls, and those balls are pressed by the inner ring and the outer ring with a predetermined pressure such that the rigidity as the bearing is increased. For this reason, the fatigue durability, load withstanding ability, and rigidity of the angular ball bearing are maintained at a predetermined level or more without increasing the size of the bearing. According to the structure, the portion of the bearing in which the load received is larger than it is at the other portion is supported by the tapered roller bearing which exhibits superior load withstanding ability, and the portion in which the load received is not very large is supported by the angular ball bearing with which lubrication performance is easily ensured. In this manner, if the angular ball bearing is used, the rotation resistance of the rotating shaft can be significantly reduced and the seizure at the bearing can be inhibited even if the amount and the viscosity of the lubricating oil of the final reduction gear device are reduced. Moreover, the portion of the rotating shaft in which the load received is large is supported by the tapered roller bearing, and the other portion is supported by the angular ball bearing in which the load withstanding ability is ensured as mentioned above. Therefore, the load withstanding ability of the bearing for supporting the rotating shaft never becomes insufficient.

In the second aspect of the invention, of the portions of the rotating shaft supported by the plurality of bearings, at least the portion closest to the bevel pinion may be supported by the tapered roller bearing, and the other portion may be supported by the angular ball bearing having the plurality of raceways for balls between the inner ring and the outer ring.

In the portion of the rotating shaft that is close to the gear of the final reduction gear device, the radial load and thrust load acting as a reaction force caused by the rotation of the rotating shaft become large and deflection of the rotating shaft also becomes large when these loads are applied. With the angular ball bearing, the balls and the inner ring, as well as the balls and the outer ring, respectively, contact in a state of almost point contact, such that both of the contact areas are small. Therefore, an oil film is easily formed between the contact portions and lubrication performance is easily ensured. In addition, the angular ball bearing receives the radial load and thrust load acting on the rotating shaft with the balls, and those balls are pressed by the inner ring and the outer ring with a predetermined pressure such that the rigidity as the bearing is increased. For this reason, the fatigue durability, load withstanding ability, and rigidity of the angular ball bearing are maintained at a predetermined level or more without increasing the size of the bearing. According to the aforementioned structure, the portion that is close to the gear of the rotating shaft is supported by the tapered roller bearing which exhibits superior fatigue durability, load withstanding ability, and rigidity, and the portion distanced from the aforementioned gear is supported by the angular ball bearing with which lubrication performance is easily ensured. In this manner, if the angular ball bearing is used, the rotation resistance of the rotating shaft can be significantly reduced and seizure at the bearing can be inhibited even if the amount and the viscosity of the lubricating oil of the final reduction gear device are reduced. Moreover, the portion close to the gear of the rotating shaft is supported by the tapered roller bearing, and the other portion is supported by the angular ball bearing in which the fatigue durability, load withstanding ability, and rigidity are ensured as mentioned above. Therefore, the fatigue durability, load withstanding ability, and rigidity of the bearing supporting the rotating shaft never becomes insufficient.

### BRIEF DESCRIPTION OF THE DRAWINGS

FIG. 1 is a sectional view of an inner structure of a final reduction gear device of a vehicle which is a bevel gear transmission to which a support structure of a rotating shaft according to one embodiment is applied;

FIG. 2 is an enlarged sectional view of a tapered roller bearing installed in the final reduction gear device;

FIG. 3 is an enlarged sectional view of an angular ball bearing installed in the final reduction gear device;

FIG. 4 is a time chart explaining an implemented embodiment of an Experiment 1 in which the performance of the tapered roller bearing is compared with that of the angular ball bearing;

FIG. 5 is a graph showing the results of an Experiment 2 in which the performance of the tapered roller bearing is compared with that of the angular ball bearing;

FIG. 6 is a time chart a graph showing the results of an Experiment 3 in which the performance of the tapered roller bearing is compared with that of the angular ball bearing; and

FIG. 7 is a sectional view of an inner structure of a final reduction gear device of a vehicle to which a support structure of a rotating shaft, which is art related to the invention, is applied.

### DETAILED DESCRIPTION OF PREFERRED EMBODIMENTS

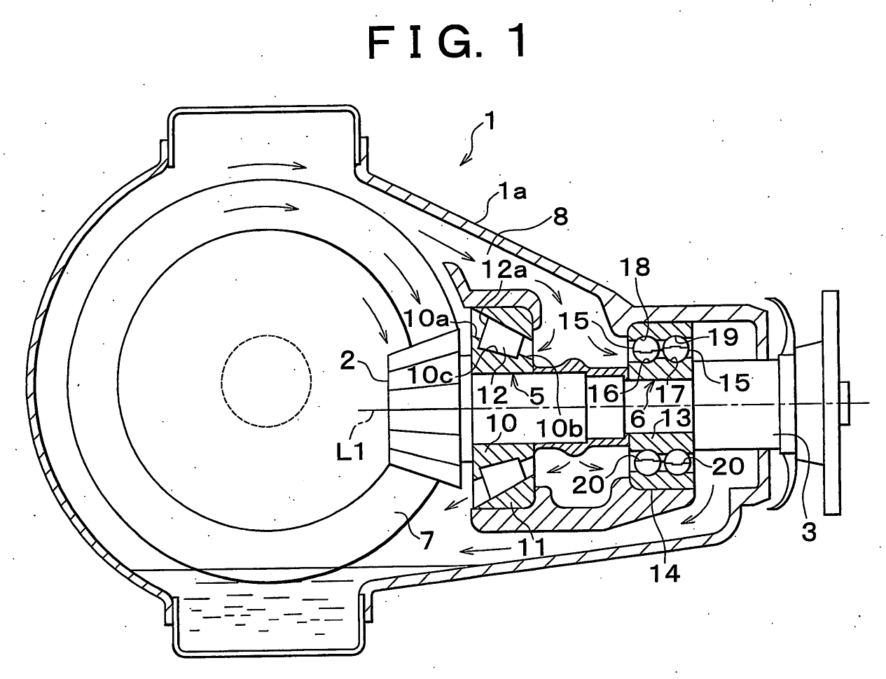

Hereafter, an embodiment in which the invention is applied to a final reduction gear device of a vehicle will be explained with reference to FIGS. 1 through 6.

As shown in FIG. 1, a bevel pinion 2 provided in a bevel gear transmission 1 is connected to a rotating shaft 3 which transfers rotation between an engine and a wheel. The rotating shaft 3 is rotatably supported by two types of bearings: a tapered roller bearing 5 and an angular ball bearing 6 of a type having a plurality of rows in the bevel gear transmission 1. Moreover, the rotation of the rotating shaft 3 due to driving of the engine is transferred to the wheel side through a bevel wheel 7 which is engaged with the bevel pinion 2.

Lubricating oil is enclosed in a housing 1a of the bevel gear transmission 1. When the bevel wheel 7 rotates with the rotation of the rotating shaft 3, the lubricating oil accumulated in the lower portion of the bevel pinion 7 is agitated and scooped up in the housing 1a. As shown by the arrow in FIG. 1, the lubricating oil which is scooped up is supplied to the tapered roller bearing 5 and the angular ball bearing 6 through a passage 8 in the housing 1a and lubricates the tapered roller bearing 5 and the angular ball bearing 6.

When the rotating shaft 3 rotates, it rotates with the bevel wheel 7 engaged with the bevel pinion 2. A reaction force produced by that engagement acts on the rotating shaft 3 as a radial load and a thrust load. Therefore, in a portion of the rotating shaft 3 that is closer to the bevel pinion 2 receives a larger radial load and thrust load, and the deflection of the rotating shaft 3 from those loads becomes large. As a result, high deflection rigidity is required. In addition, in a portion of the rotating shaft 3 that is further from the bevel pinion 2 receives a smaller radial load and thrust load, and the required amount of the deflection rigidity is small. However, in the portion of the rotating shaft 3 that is further from the bevel pinion 2 is further from the lower portion of the bevel wheel 7 where the lubricating oil accumulates in the housing 1a. Therefore, the lubricating oil does not easily spread when the rotating shaft 3 rotates and the lubricating condition becomes severe.

In the rotating shaft 3, of both of the portions supported by the tapered roller bearing 5 and the angular ball bearing 6, the portion closer to the bevel pinion 2 receives the larger radial load and thrust load than those of the portion further from the bevel pinion 2 upon rotation, and therefore, requires high deflection rigidity. However, the lubricating condition is more severe on the portion further from the bevel pinion 2 than the portion closer to the bevel pinion 2. For this reason, of both of the aforementioned portions, the portion closer to the bevel pinion 2 is supported by the tapered roller bearing 5 which exhibits superior fatigue durability, load withstanding ability, and rigidity and the like as a bearing while the portion further from the bevel pinion 2 is supported by the angular ball bearing 6 with which lubricating performance is easily ensured.

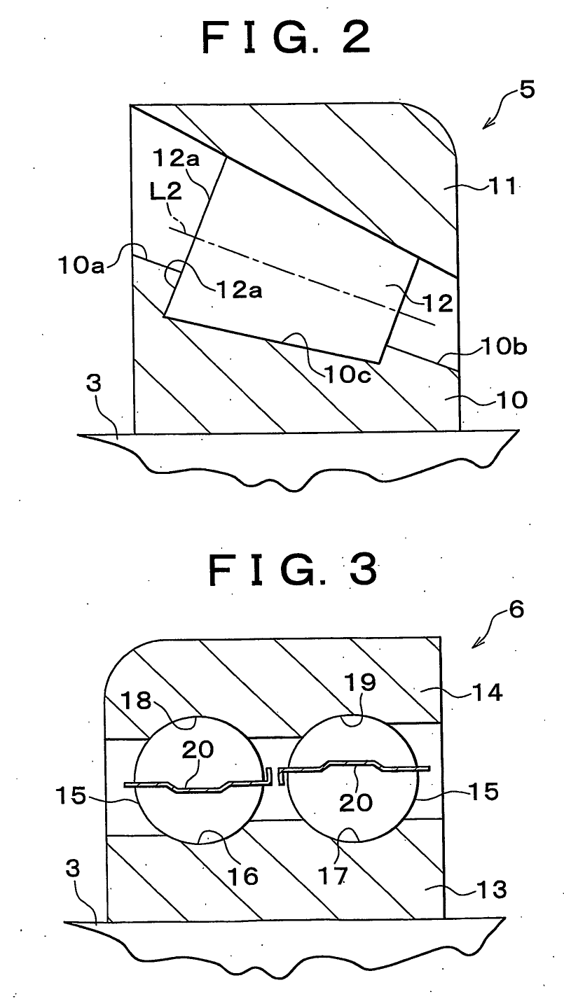

Here, the tapered roller bearing 5 and the angular ball bearing 6 will be explained in detail referring to FIG. 2 and FIG. 3.

FIG. 2 is an enlarged sectional view showing an inner structure of the tapered roller bearing 5.

The tapered roller bearing 5 is provided with a plurality of rollers 12 (only one roller is shown in the figure) disposed between an inner ring 10 and an outer ring 11 and a raceway groove 10c formed in an outer peripheral surface of the inner ring 10 so as to roll the roller 12 in a peripheral direction of the rotating shaft 3. The roller 12 is inclined such that an axial line L2 of the roller 12 is inclined with respect to an axial line L1 (FIG. 1) of the rotating shaft 3 and a distance between the axial line L2 and the outer peripheral surface of the rotating shaft 3 becomes shorter toward the side away from (to the right in FIG. 2) the bevel pinion 2. Moreover, the outer peripheral surface of the roller 12 has a taper in which the diameter is shorter further from the bevel pinion 2.

In a state where the tapered roller bearing 5 is installed on the bevel gear transmission 1 supporting the rotating shaft 3, if a predetermined pressure is applied from the inner ring 10 and the outer ring 11 to the roller 12, the rigidity of the tapered roller bearing 5 increases to the necessary level as a bearing to support the rotating shaft 3.

The outer peripheral surface of the roller 12 contacts an inner peripheral surface of the inner ring 10 (a bottom surface of the raceway groove 10c) and an inner peripheral surface of the outer ring 11 in a state of almost line contact. In addition, in the outer peripheral surface of the inner ring 10, a collar portion 10a is formed on an edge portion on the bevel pinion 2 side (to the left side in FIG. 2) and a collar portion 10b is formed on an edge portion on the opposite side (to the right side in FIG. 2) of the bevel pinion 2. Therefore, in the state where the tapered roller bearing 5 is installed on the bevel gear transmission 1 supporting the rotating shaft 3, the collar portion 10a is pressed against an end face 12a on the large diameter side of the roller 12.

When the rotating shaft 3 rotates, the inner ring 10 rotates integrally with the rotating shaft 3 and rotates relative to the outer ring 11, and the roller 12 rolls between the inner ring 10 and the outer ring 11. Then, when the rotating shaft 3 rotates so as to make the vehicle go forward, the tapered roller bearing 5 receives the radial load acting on the rotating shaft 3 and the thrust load acting in the direction to the right in FIG. 2 at the contact portion between the roller 12 and the inner ring 10, as well as between the roller 12 and the outer ring 11, respectively. In this manner, both of the loads are received at a line contact portion, so the tapered roller bearing 5 can receive the relatively large radial load and thrust load and the durability against fatigue from receiving these loads is superior.

As mentioned above, the lubricating oil is supplied to the tapered roller bearing 5 based on the rotation of the bevel wheel 7 (FIG. 1) that occurs with the rotation of the rotating shaft 3. When the tapered roller bearing 5 is supplied with lubricating oil, the lubricating oil enters between the roller 12 and the inner ring 10, as well as between the roller 12 and the outer ring 11, respectively, and an oil film is formed there so as to lubricate the tapered roller bearing 5. However, in the tapered roller bearing 5, the collar portion 10a of the inner ring 10 is pressed against the end face 12a of the roller 12 such that the lubricating oil has difficulty entering between the collar portion 10a and the end face 12a. As a result, the oil film does not form as easily there as it does at the other portion.

FIG. 3 is an enlarged sectional view showing an inner structure of the angular ball bearing 6.

The angular ball bearing 6 is provided with a plurality of balls 15 disposed between an inner ring 13 and an outer ring 14, and raceway grooves 16 to 19 which are formed in the outer peripheral surface of the inner ring 13 and the inner peripheral surface of the outer ring 14 so as to roll the balls 15 in the peripheral direction of the rotating shaft 3. In the angular ball bearing 6, the raceway grooves 16 and 18, as well as the raceway grooves 17 and 19, respectively, opposed one another respectively. Moreover, the plurality of balls 15 are retained by a cage 20 between the raceway grooves 16 and 18, as well as the raceway grooves 17 and 19, respectively. Therefore, in the angular ball bearing 6, a plurality of rows (two rows) of balls 15 roll between the inner ring 13 and the outer ring 14 along the raceway grooves 16 to 19 in the peripheral direction of the rotating shaft 3.

In a state where the angular ball bearing 6 is installed on the bevel gear transmission 1 supporting the rotating shaft 3, a predetermined pressure is applied from the inner ring 13 and the outer ring 14 to the balls 15. Therefore, inner faces of the raceway grooves 16 to 19 contact the outer face of the balls 15. The contact portion between the balls 15 and the inner ring 13, as well as the contact portion between the balls 15 and the outer ring 14 in the angular ball bearing 6, respectively, are almost in point contact. Moreover, the contact areas are smaller than those of the contact portions between a roller of a tapered roller bearing of the same size and inner and outer rings. Therefore, the resistance of the angular ball bearing 6 when the inner ring 13 rotates relative to the outer ring 14 and the balls 15 rolls is smaller than when the roller 12 rolls in the tapered roller bearing 5.

The lubricating oil is supplied to the angular ball bearing 6 based on the rotation of the bevel wheel 7 (FIG. 1) with the rotation of the rotating shaft 3 in the same manner as the tapered roller bearing 5. In addition, when the tapered roller bearing 5 is supplied with lubricating oil, the lubricating oil enters between the balls 15 and the inner ring 13, as well as between the balls 15 and the outer ring 14, respectively, and an oil film is formed so as to lubricate the angular ball bearing 6. In a ball bearing such as the angular ball bearing 6, the contact surfaces, in which the contact portion between the balls and the inner ring, as well as between the balls and the outer ring, are almost in point contact, are small. Therefore, the oil film is easily formed between the contact portions, and lubrication performance is easily ensured in the environments in which it is used having a severe lubricating condition.

In the angular ball bearing 6, when the rotating shaft 3 rotates, the inner ring 13 rotates integrally with the rotating shaft 3, and rotates relative to the outer ring 14, and the balls 15 rolls between the inner ring 13 and the outer ring 14. Then, when the rotating shaft 3 rotates so as to make the vehicle go backward, the angular ball bearing 6 receives the radial load acting on the rotating shaft 3 and the thrust load acting in the direction to the left in FIG. 3 at point contact portions between the balls 15 and the inner ring 13, as well as between the balls 15 and the outer ring 14, respectively. Therefore, the fatigue durability and the load withstanding ability necessary for supporting the rotating shaft 3 can be ensured by using the angular ball bearing 6 of a type having a plurality of rows for supporting the rotating shaft 3 without increasing the size of the bearing. Moreover, at least the level of the fatigue durability is able to be the same as that of the tapered roller bearing of the same size.

Moreover, in the angular ball bearing 6, the balls 15 are pressed with a predetermined pressure by the inner ring 13 and the outer ring 14 such that the rigidity is increased. Therefore, the level of the rigidity as a bearing supporting the rotating shaft 3 can be maintained at the necessary level or more without increasing the size of the bearing.

Next, Experiments 1 to 3 conducted to compare the performance of a tapered roller bearing with that of an angular ball bearing, and the results thereof will be described hereafter.

[Experiment 1]

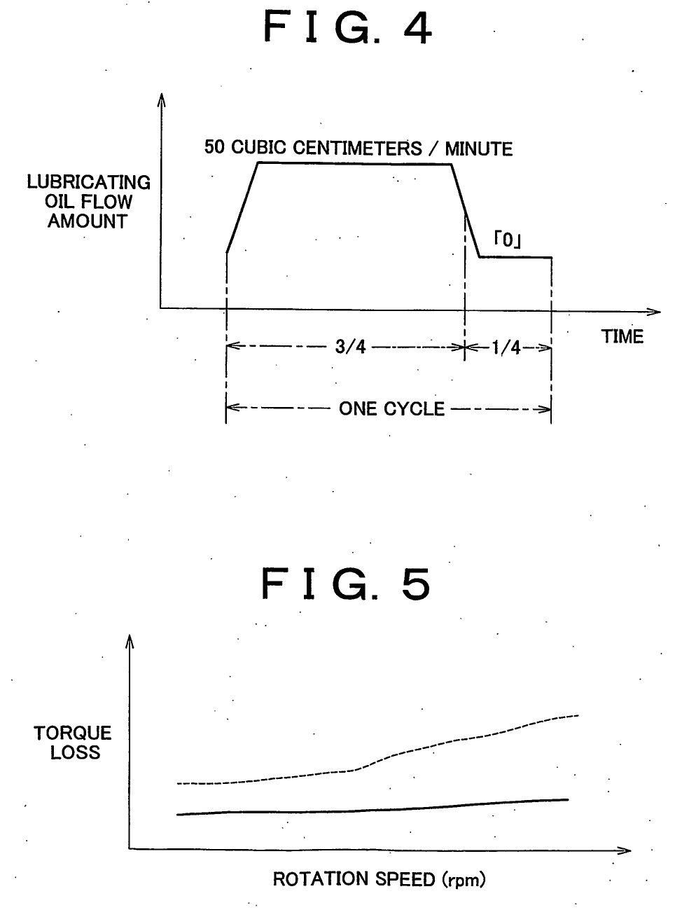

In this experiment, a tapered roller bearing and an angular ball bearing of the same outer and inner diameters are respectively installed on a rotating shaft, and the rotation speed of the rotating shaft is set to 5000 rpm, for example, with the same amount of the thrust load applied to both of the tapered roller bearing and the angular ball bearing. In this state, lubricating oil is supplied to both of the bearings for a predetermined time at a rate of 50 cubic centimeters per minute, for example. Then, the lubricating oil supply is stopped for a predetermined time. The ratio of the supply time of the lubricating oil and the stop time thereof is set to 3:1, for example. One cycle is from start-up time of the lubricating oil supply to the stop time thereof. The cycle is repeated ten times in total. FIG. 4 shows the shift in the amount of lubricating oil flowing into both of the bearings during the aforementioned one cycle.

Then, the rotation speed of the rotating shaft is increased successively to 6000 rpm, 7000 rpm, 8200 rpm, and 8800 rpm, and the experiment is conducted according to the aforementioned procedures for each rotation speed. Further, the same experiment is conducted changing the amount of the lubricating oil in increments of a predetermined value, and the tapered roller bearing was compared with the angular ball bearing to see at which level of rotation speed and lubricating oil flow amount seizure occurs.

As a result of the aforementioned experiment, with the tapered roller bearing, seizure occurred when the lubricating oil supply is conducted at a rate of 100 cubic centimeters per minute and the rotation speed of the rotating shaft is 8800 rpm. On the other hand, with the angular ball bearing, seizure never occurred even when the lubricating oil supply is conducted at a small rate of 10 cubic centimeters per minute, for example, regardless of the rotation speed of the rotating shaft. Therefore, the angular ball bearing 6 exhibits superior lubrication performance compared to that of a tapered roller bearing of the same size.

[Experiment 2]

In this experiment, a tapered roller bearing and an angular ball bearing of the same outer and inner diameters are respectively installed on the rotating shaft, and the same amount of the thrust load is applied to both the tapered roller bearing and the angular ball bearing. At the same time, the same amount of lubricating oil is supplied to both of the bearings, and the respective rotation resistances of the rotating shaft caused by both of the bearings is measured while gradually increasing the rotation speed of the rotating shaft.

The results of the experiment are shown in a graph of FIG. 5. In this figure, a dotted line shows how the rotation resistance (torque loss) of the rotating shaft caused by the tapered roller bearing shifts with respect to an increase in the rotation speed. A solid line shows how the rotation resistance (torque loss) of the rotating shaft caused by the angular ball bearing shifts with respect to an increase in the rotation speed.

From these results, it is evident that the rotation resistance caused by the angular ball bearing is less by 50 percent or more throughout the entire rotation speed region than that caused by the tapered roller bearing. Therefore, it is clear that the rotation resistance of the rotating shaft can be reduced by using the angular ball bearing as a bearing of the rotating shaft.

[Experiment 3]

In this experiment, a tapered roller bearing and an angular ball bearing of the same outer and inner diameters are respectively installed on a rotating shaft, and the same amount of the thrust load is applied to both the tapered roller bearing and the angular ball bearing. In this state, the rotation speed of the rotating shaft is maintained at a constant speed, and only dynamic viscosity is changed without changing the supply amount of the lubricating oil which lubricates the bearing. Then the rotation resistance of the rotating shaft caused by both of the bearings is measured for each dynamic viscosity of the lubricating oil.

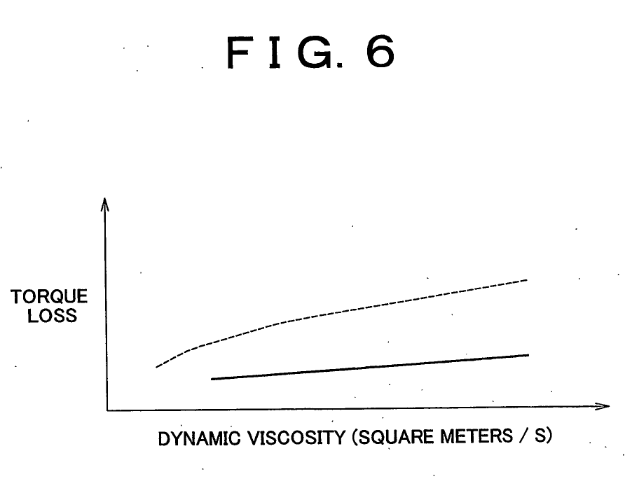

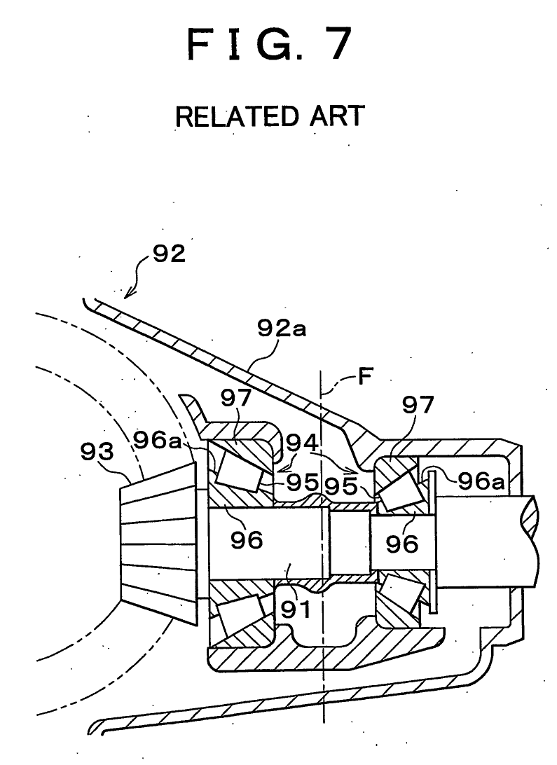

The results of the experiment are shown in the graph of FIG. 6. In this figure, the dotted line shows how the rotation resistance (torque loss) of the rotating shaft caused by the tapered roller bearing shifts with respect to a change in the dynamic viscosity of the lubricating oil. The solid line shows how the rotation resistance (torque loss) of the rotating shaft caused by the angular ball bearing shifts with respect to a change in the dynamic viscosity of the lubricating oil.

From these results, the rotation resistance of the rotating shaft caused by the tapered roller bearing increases excessively when the dynamic viscosity of the lubricating oil is large. On the other hand, the rotation resistance of the rotating shaft caused by the angular ball bearing is not easily affected by the dynamic viscosity of the lubricating oil. The rotation resistance does not change much whether the dynamic viscosity of the lubricating oil is small or large, and is maintained at a low state. Therefore, it is clear that it is possible to reduce the viscosity of the lubricating oil more by using the angular ball bearing as a rotating shaft, than by using the tapered roller bearing.

Next, the advantages when the rotating shaft 3 is supported by the tapered roller bearing 5 and the angular ball bearing 6 in the aforementioned manner will be explained.

With the angular ball bearing 6, the contact between the balls 15 and the inner ring 13, as well as the contact between the balls 15 and the outer ring 14, respectively, are almost in point contact so the contact areas are small. As a result, an oil film is easily formed between them, therefore, it is easy to ensure lubrication performance under a severe lubricating condition. In addition, in the angular ball bearing 6, the radial load and the thrust load acting on the rotating shaft 3 are received at the point contact portion between the balls 15 and the inner ring 13, as well as the balls 15 and the outer ring 14, respectively. At the same time, the balls 15 are pressed by the inner ring 13 and the outer ring 14 with a predetermined pressure such that the rigidity is increased. As a result, the fatigue durability, load withstanding ability, and rigidity of the angular ball bearing 6 are maintained at the necessary predetermined level or more for supporting the rotating shaft 3 without increasing the size of the bearing.

Of the two portions supported by the bearing of the rotating shaft 3, the portion distanced from the bevel pinion 2 is supported by the angular ball bearing 6. At this portion, high deflection rigidity of the rotating shaft 3 is not required as much as it is for the other portion, and the load received is not large. However, the lubricating condition is under a severe environment. On the other hand, at the other portion of the aforementioned portions, the lubricating condition is not severe, but high deflection rigidity of the rotating shaft 3 is required, and the load received is large. Therefore, this portion is supported by the tapered roller bearing 5 which exhibits superior fatigue durability, load withstanding ability, and rigidity.

As mentioned above, in the rotating shaft 3, the portion where lubrication is difficult is supported by the angular ball bearing 6, and the other portion where lubrication is not difficult is supported by the tapered roller bearing 5. Therefore, when the amount and the viscosity of the lubricating oil of the bevel gear transmission 1 are reduced just to about the point where seizure does not occur in the tapered roller bearing 5 in order to reduce the rotation resistance of the rotating shaft 3, the rotation resistance of the rotating shaft can be significantly reduced. In addition, in the rotating shaft 3, the portion where high deflection rigidity is required and a larger load is received is supported by the tapered roller bearing 5. On the other hand, the portion where high deflection rigidity is not required and a large load is not received is supported by the angular ball bearing 6. As a result, the fatigue durability, load withstanding ability, and rigidity supporting the rotating shaft 3 never become insufficient.

The following effects are obtained according to the detailed description of this embodiment.

(1) In the rotating shaft 3, the portion distanced from the bevel pinion 2 where the lubricating condition is severe is supported by the angular ball bearing 6 with which lubrication performance is easily ensured, and the other portion is supported by the tapered roller bearing 5 which exhibits superior fatigue durability, load withstanding ability, and rigidity. Therefore, in the tapered roller bearing 5, if the amount and viscosity of the lubricating oil of the bevel gear transmission 1 are reduced just to about the point where seizure does not occur between the portions, i.e., between the collar portion 10a of the inner ring 10 and the end face 12a of the roller 12, where the lubricating oil has difficulty entering such that the oil film has difficulty forming, the rotation resistance of the rotating shaft 3 can be significantly reduced. At the same time, seizure can be inhibited at the bearing. Moreover, in the angular ball bearing 6, the resistance when the ball 15 rotates with the rotation of the rotating shaft 3 is significantly reduced compared to when the roller 12 rotates in the tapered roller bearing 5, thereby contributing to the reduction in the rotation resistance of the rotating shaft 3. In this manner, it is possible to significantly reduce the rotation resistance of the rotating shaft 3, and inhibit the seizure at the bearing supporting the rotating shaft 3 at the same time.

(2) In general, with a ball bearing of a type having a single row provided with a single row of balls in an inner ring and an outer ring, the inner ring and the balls, as well as the outer ring and the balls, respectively, contact in a state of almost point contact, such that both of the contact areas are small. Therefore, the fatigue durability, load withstanding ability, and rigidity are inferior to those of a roller bearing of the same size. For this reason, if the ball bearing of a type having a single row is used as a bearing supporting the rotating shaft 3, the bearing size needs to be larger so as to obtain the necessary fatigue durability, load withstanding ability, and rigidity, which is not a negligible problem. However, if the angular ball bearing 6 of a type having a plurality of rows provided with the plurality of balls 15 disposed between the inner ring 13 and the outer ring 14 is used as a bearing supporting the rotating shaft 3, the load from the rotating shaft 3 is received at the contact portion between the plurality of balls 15 and the inner ring 13, as well as between the plurality of balls 15 and the outer ring 14. As a result, the necessary fatigue durability, load withstanding ability, and rigidity are ensured without increasing the size of the bearing. In addition, in the angular ball bearing 6, the balls 15 are pressed with a predetermined pressure by the inner ring 13 and the outer ring 14 such that the rigidity is increased. Therefore, the level of the rigidity as a bearing supporting the rotating shaft 3 can be maintained at the necessary level or more without increasing the size of the bearing.

(3) With a ball bearing such as the angular ball bearing 6, it is difficult to ensure the load withstanding ability. However, the angular ball bearing 6 is distanced from the bevel pinion 2 in the rotating shaft 3, and supports the portion which receives a small load. For this reason, there is no problem in terms of the load withstanding ability of the bearing when the angular ball bearing 6 is used as a bearing supporting rotating shaft 3.

(4) The tapered roller bearing 5 supports the portion closer to the bevel pinion 2 in the rotating shaft 3, i.e., the portion where the lubricating condition is not severe, and where high deflection rigidity of the rotating shaft 3 is required, which receives a large load. Therefore, in the aforementioned portion, the deflection rigidity of the rotating shaft 3, the fatigue durability, and load withstanding ability of the tapered roller bearing 5 supporting that portion never become insufficient. In addition, regarding the portion distanced from the bevel pinion 2 in the rotating shaft 3, the fatigue durability, load withstanding ability and rigidity are increased as mentioned above. Moreover, that portion is supported by the angular ball bearing 6 with at least the same fatigue durability as that of the tapered roller bearing 5. Therefore, the deflection rigidity of the rotating shaft 3, the fatigue durability and load withstanding ability of the bearing never become insufficient.

(5) In the rotating shaft 3, the portion where high deflection rigidity is required is supported by the tapered roller bearing 5 which exhibits superior rigidity, and the portion where high deflection rigidity is not required is supported by the angular ball bearing 6 which exhibits inferior rigidity to that of the tapered roller bearing 5. For this reason, when the thrust load acts on the rotating shaft 3 due to the rising temperature and the like around the rotating shaft 3, that load can be released on the side of the angular ball bearing 6, and an excessive increase in the pressure in the thrust direction applied from the inner and outer rings in the bearings 5 and 6 to the roller 12 and the balls 15 is inhibited by the thrust load. Therefore, it is possible to inhibit seizure and an increase in the rotation resistance in the bearings 5 and 6 due to the aforementioned increased pressure.

In addition, the aforementioned embodiment can be modified as follows.
In the foregoing embodiment, the angular ball bearing 6 of a type having a plurality of rows provided with the plurality of balls 15 disposed between the inner ring 13 and the outer ring 14 as the angular ball bearing 6 is shown as an example. Alternatively, however, the angular ball bearing of a type having a single row provided with the plurality of balls between the inner and outer rings may be installed parallel, adjacent to one another in the axial direction of the rotating shaft 3. In this case, the joining surfaces of the angular ball bearing adjacent to one another must be precisely formed and controlled, but a similar effect as that of the aforementioned embodiment can be obtained. On the other hand, if the angular ball bearing 6 of a type having a plurality of rows is used as mentioned in the aforementioned embodiment, the trouble of precisely forming and controlling the aforementioned joining surface is eliminated.
In the foregoing embodiment, as a portion in the rotating shaft 3 where the lubricating condition is severe, the portion distanced from the bevel pinion 2 of the rotating shaft 3 is shown as an example. However, in a case such as where the rotating shaft 3 is inclined such that the portion further from the bevel pinion 2 is increasingly lower, the lubricating oil or the like adhered to the rotating shaft 3 flows in the direction away from the bevel pinion 2. Therefore, it is possible that the lubricating condition may become more severe at the portion closer to the bevel pinion 2. In addition, it is possible that the lubricating condition may become more severe at the portion closer to the bevel pinion 2 of the rotating shaft 3 depending on the structure of the path 8 in the housing 1a of the bevel gear transmission 1. In these cases, the portion closer to the bevel pinion 2 of the rotating shaft 3 may be supported by the angular ball bearing 6.
The tapered roller bearing 5 supporting the rotating shaft 3 may be changed to another type of bearing which can ensure the necessary lubrication performance, fatigue durability, load withstanding ability, and rigidity and the like.
In this embodiment, the invention is applied to a device that supports the rotating shaft 3 by two bearings. However, the invention may also be applied to a device that supports the rotating shaft 3 by three or more bearings, for example.
The invention is not limited to a final reduction gear device, and may be applied in any bevel gear transmission having a main rotating direction defined as a forward direction and optionally a sub rotating direction defined as a reverse direction.
In the bevel gear transmission 1 according to the present invention, in a rotating shaft 3 connected to a bevel pinion 2, a portion distanced from the bevel pinion 2, in which a lubricating condition is severe, is supported by an angular ball bearing 6 with which lubrication performance is easily ensured, and the other portion is supported by a tapered roller bearing 5 which exhibits superior fatigue durability, load withstanding ability, and rigidity.

1. A bevel gear transmission, in particular for the use as a final gear device in an automobile, comprising:
a bevel wheel meshing with a bevel pinion;
a rotating shaft supporting said bevel pinion, said rotating shaft being supported by a plurality of bearings, wherein
the one bearing arranged close to the bevel pinion is a tapered roller bearing disposed such that a thrust load of the rotating shaft is received by this tapered roller bearing, when said rotating shaft rotates in a forward direction and the other bearing arranged far from the bevel pinion is disposed such that the thrust load of the rotating shaft is received by the other bearing, when said rotating shaft rotates in a reverse direction
characterized in that
the other bearing is a ball bearing.

2. The bevel gear transmission according to claim 1, characterized in that the other bearing is an angular ball bearing having a plurality of raceways for balls between an inner ring and an outer ring.

3. The bevel gear transmission according to claim 1, characterized in that a load received by the other bearing is smaller than a load received by the one bearing.

4. The bevel gear transmission according to claim 1, characterized in that a deflection rigidity to be required to the one bearing supporting a first portion of the rotating shaft is higher than a deflection rigidity to be required to the other bearing supporting a second portion of the rotating shaft.

5. The bevel gear transmission according to claim 1, characterized in that a fatigate durability of the one bearing is substantially equivalent to that of the other bearing.

6. The bevel gear transmission according to claim 1, characterized in that a lubricating condition at a second portion of the rotating shaft being supported by the other bearing is more severe than a lubricating condition at a first portion of the rotating shaft being supported by the one bearing.

7. The bevel gear transmission according to claim 1, characterized in that the tapered roller bearing has a structure such that a plurality of rollers is disposed between an inner ring and an outer ring, an axial line of the roller bearing is inclined with respect to an axial line of the rotating shaft, and is disposed inclined such that the distance between the axial line of the roller bearing and an outer peripheral surface of the rotating shaft becomes shorter as the distance from the bevel wheel increases, and
the roller has a taper in which the diameter becomes smaller as the distance from the bevel wheel increases.

8. The bevel gear transmission according to claim 1, characterized in that said plurality of bearings is lubricated by oil being scooped up by said bevel wheel.

9. The bevel gear transmission according to claim 8, characterized in that the forward rotating direction of the bevel wheel, which is a main rotating direction, is such that a peripheral of said bevel wheel moves downward at the side of said bevel pinion and a passage is formed in a housing of the bevel gear transmission, said passage extending on a top side of the housing from the bevel wheel toward the plurality of bearings in substantial in a tangential direction of the peripheral of the bevel wheel, such that lubricating oil may be supplied by the rotating bevel wheel from the bottom of the housing to the plurality of bearings.
